(19) United States
(12) Patent Application Publication
(10) Pub. No.: US 2026/0115877 A1
(43) Pub. Date: Apr. 30, 2026

(54) BLOWOUT PREVENTER RAM REMOVAL TOOL AND PROCESS, AND BLOWOUT PREVENTER INCLUDING A RAM REMOVAL TOOL

(71) Applicant: Bellofram Acquisition II, LLC, Newell, WV (US)

(72) Inventor: Tyler Remington, Norman, OK (US)

(73) Assignee: Bellofram Acquisition II, LLC, Newell, WV (US)

(21) Appl. No.: 19/368,816

(22) Filed: Oct. 24, 2025

Related U.S. Application Data
(60) Provisional application No. 63/711,404, filed on Oct. 24, 2024.

(51) Int. Cl. B25B 27/02; E21B 33/06

(52) U.S. Cl. CPC B25B 27/023; E21B 33/061

(57) ABSTRACT

A blowout preventer ram removal tool includes a base adapted to be engaged with an associated blowout preventer body such that the base spans an associated ram bore in which an associated ram is located. A ram removal bolt is engaged with the base and adapted to be selectively advanced and retracted relative to the base, wherein the ram removal bolt comprises a stud that is adapted to be mated with the associated ram. Retraction of the ram removal bolt relative to the body when the stud of the ram removal bolt is mated with the associated ram retracts the associated ram relative to the associated ram bore. A blowout preventer ram removal process is also disclosed, as is a blowout preventer in combination with a blowout preventer ram removal tool.

### CROSS-REFERENCE TO RELATED APPLICATION

This application claims priority from and benefit of the filing date of U.S. provisional application Ser. No. 63/711,404 filed October 24, 2024, and the entire disclosure of said provisional application is hereby expressly incorporated by reference into the present application.

### FIELD

This disclosure relates to a blowout preventer (BOP) ram removal tool and process for removing a blowout preventer ram from the blowout preventor body. A blowout preventer including a ram removal tool is also disclosed.

### BACKGROUND

As the rams of the blowout preventers are exposed to crude oil, moisture, and other various gases and liquids, over time they can seize up or wear out. It is part of normal maintenance to replace or inspect BOP rams to ensure they still can work. During such inspection and/or replacement process, the rams must be removed from their operative position within a bore formed in the BOP body. In certain cases, the ram can be difficult to remove from its operative position within the BOP body. As such, a need has been identified for a blowout preventor ram removal tool and process.

### SUMMARY

In accordance with one aspect of the present development, a blowout preventer ram removal tool comprises a base adapted to be engaged with an associated blowout preventer body such that the base spans an associated ram bore in which an associated ram is located. A ram removal bolt is engaged with the base and adapted to be selectively advanced and retracted relative to the base, wherein said ram removal bolt comprises a stud that is adapted to be mated with the associated ram. Retraction of the ram removal bolt relative to the body when the stud of the ram removal bolt is mated with the associated ram retracts the associated ram relative to the associated ram bore.

In accordance with another aspect of the present development, a blowout preventer ram removal process includes engaging a base of a ram removal tool with a blowout preventer body such that the base spans a ram bore of the blowout preventer body in which a ram is located. The ram removal tool includes a ram removal bolt threadably engaged with the base and adapted for being rotated in first and second directions relative to the base to respectively advance and retract the ram removal bolt relative to the base. The process further includes engaging the ram removal bolt with the ram in the ram bore and rotating the ram removal bolt relative to the base in the second direction to retract the ram removal bolt relative to the base such that the ram removal bolt and the ram engaged with the ram removal bolt are moved outwardly relative to the ram bore.

In accordance with a further aspect of the present development, a blowout preventer comprises a body including a bore. A ram is movably located in the bore, wherein the ram includes a receiver notch. The blowout preventer further comprises a ram removal tool including a base engaged with the body and a ram removal shaft rotatably engaged with the base, wherein rotation of the ram removal shaft in a first direction relative to the base advances the ram removal shaft into the bore and rotation of the ram removal shaft in a second direction retracts the ram removal shaft relative to the bore. A first end of the ram removal shaft includes a driving head, and a second end of the ram removal shaft includes a stud that is located in the receiver notch of the ram such that the stud is captured in the receiver notch whereby rotation of the ram removal shaft in the second direction retracts the ram from the bore.

### BRIEF DESCRIPTION OF THE DRAWINGS

FIG. 1 is a top view of a blowout preventer (BOP) ram removal tool provided in accordance with an embodiment of the present development.

FIG. 2 is a side view of the BOP ram removal tool of FIG. 1.

FIG. 3 is a top view of only the base portion of the BOP ram removal tool of FIGS. 1 & 2.

FIG. 3A is a section view of the base portion of the tool as taken at A – A of FIG. 2.

FIG. 4 is an isometric view of the BOP ram removal tool of FIG. 1.

FIG. 5 is a view of a partially disassembly BOP showing a BOP body including a ram bore in which a ram is operatively positioned (a bonnet of the BOP has been removed from the body to illustrate the ram bore and ram.

FIG. 6 is similar to FIG. 5, but also shows the BOP ram removal tool of FIG. 1 operatively engaged with the BOP body for removal of the ram from the ram bore, with the tool shown in a first operative state in which the removal bolt is advanced into the bore and advanced relative to the base of the tool and operatively engaged with a stud receiver notch defined in an outer face of the ram.

FIG. 7 is similar to FIG. 6, but shows the tool in a second operative state in which the removal bolt is retracted from the bore and retracted relative to the tool base so that the associated ram that is operatively engaged with the removal bolt is at least partially retracted from or withdrawn from the ram bore to facilitate removal of the ram from the ram bore.

FIG. 8 shows the BOP ram removal tool and associated ram operatively engaged therewith separated from the BOP body to allow repair and/or replacement of the ram.

FIGS. 9A & 9B respectively provide an isometric view and a side view of a BOP ram removal tool in accordance with an alternative embodiment of the present development.

### DETAILED DESCRIPTION

The following description with reference to the accompanying drawings is provided to assist in a comprehensive understanding of one or more embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. Various exemplary embodiments of the present disclosure are not limited to the specific details of different embodiments and should be construed as including all changes and/or equivalents or substitutes included in the ideas and technological scope of the appended claims. In describing the drawings, where possible similar reference numerals are used for similar elements.

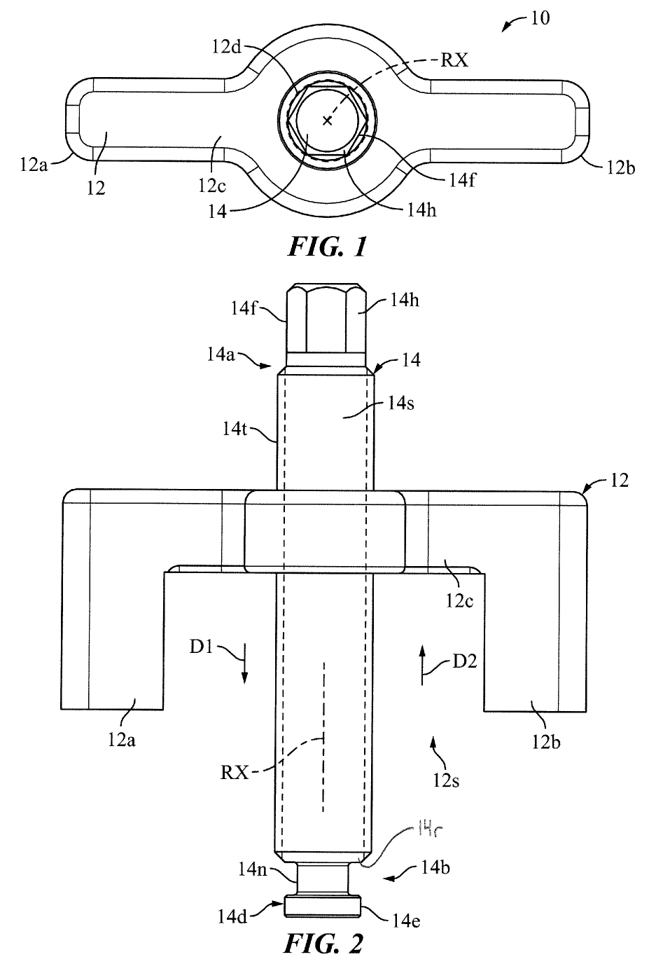

FIG. 1 is a top view of a blowout preventer (BOP) ram removal tool 10 provided in accordance with an embodiment of the present development. FIG. 2 is a side view of the BOP ram removal tool 10 of FIG. 1. The tool 10 comprises a base 12 and a ram removal bolt 14 that is threadably engaged with the base 12 so as to be rotatable relative to the base 12 about a ram removal axis RX for selective advancement and retraction of the ram removal bolt 14 relative to the base 12 when the ram removal bolt is respectively rotated relative to the base 12 in a first direction (for advancement) and an opposite second direction (for retraction).

The ram removal bolt 14 includes an elongated shaft 14s that includes helical threads 14t along all or at least a portion of its axial length. A first or outer end 14a of the ram removal bolt 14 includes a driving head 14h that can have any one or more desired structures for being non-rotatably engaged by an associated driving tool used to rotate the ram removal bolt 14 in first and second opposite directions relative to the base 12. In the illustrated example, the driving head 14h comprises a non-circular structure including one or more flats 14f (such as a square head with four flats, the illustrated hexagonal head with six flats, or any other non-circular shape) and the head 14h is adapted to be non-rotatably engaged with a wrench or other corresponding driving tool for rotating the ram removal bolt 14 about the ram removal axis RX in the first and second directions to advance and retract the ram removal bolt, respectively, relative to the tool base 12.

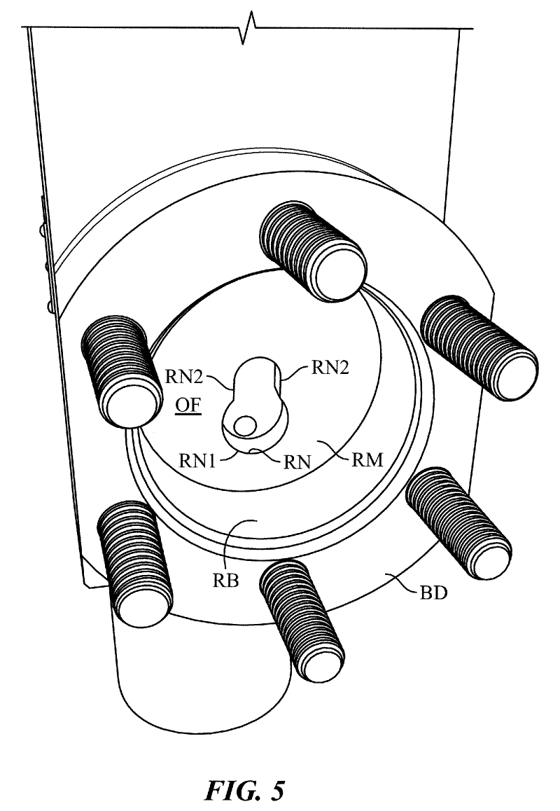

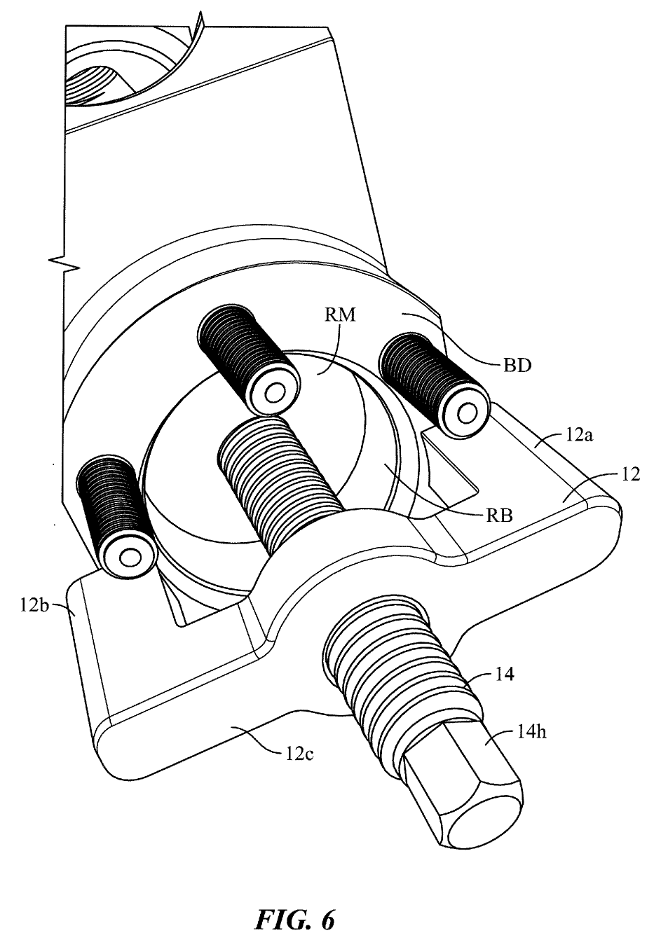

At its second or inner end 14b, opposite the first end 14a, the ram removal bolt 14 comprises a ram engagement stud 14d for selectively operatively engaging an associate BOP ram. The exact structure and/or dimensions of the ram engagement stud 14d can vary so that the ram engagement stud 14d is configured to mate with a corresponding stud receiver notch, recess, slot, and/or other receiving structure RN (see FIG. 5) or location provided on the associated ram RM to be removed from a BOP body BD as described below. In the illustrated embodiment, the ram engagement stud 14d comprises a reduced diameter neck 14n that coaxially projects outwardly from the second end 14b of the bolt shaft 14s that is reduced in diameter relative to the remainder of the shaft 14s such that a shoulder 14r is defined where an inner end of the neck 14n is connected to the remainder of the shaft 14s. The ram engagement stud 14d further comprises a flanged or enlarged head 14e that is radially enlarged relative to the neck 14n and that is connected to the remainder of the shaft 14s by the neck 14n and that is located at an outer end of the neck 14n such that the reduced diameter neck 14n is located axially between the enlarged/flanged head 14e and the shoulder 14r. As shown, the enlarged head 14e includes a circular periphery but other shapes can be used. In the illustrated non-limiting example, the neck 14n and head 14e are formed as part of a one-piece structure with the remainder of the ram removal bolt 14, and the bolt 14, itself, including the driving head 14h is a one-piece structure.

With reference to FIG. 5., the illustrated BOP ram includes an outer face OF in which the stud receiver notch RN is defined. The illustrated stud receiver notch RN comprises a keyhole shape including a first portion RN1 comprising an enlarged opening and a second undercut slotted portion RN2 connected to the first portion RN1 that is reduced in size relative to the first portion RN1 and undercut such that the flanged head 14e of the ram removal bolt head 14h can be inserted into the first portion RN1 and the neck 14n and flanged head 14e can then be slid into the second portion RN2 such that the flanged head 14e is axially captured in the undercut of the second portion RN2 and cannot be removed unless and until the flanged head 14e is moved laterally back to the enlarged first portion RN1.

Referring to all of FIGS. 1 – 3A and FIG. 4, the base 12 of the tool 10 defines a bridge structure comprising first and second parallel, spaced-apart, axially extending legs 12a,12b connected by a crossbar 12c. In one embodiment, the base 12 is a one-piece construction that can be metal or polymeric or other material that is molded, cast, or otherwise constructed. Alternatively, the base 12 can be fabricated from multiple components that can be defined from metal, a polymeric material, or a combination of such materials or others. The legs 12a,12b are equal length and a ram receiving space 12s is defined between the legs 12a,12b. The crossbar 12c comprises an internally threaded through-bore 12d that can be located midway or equidistant between the legs 12a,12c and that is defined coaxially with the ram removal axis RX. The internally threaded through-bore 12d is conformed and dimensioned for threadably mating with the external threads 14t of the ram removal bolt 14 such that rotation of the bolt in first and second directions respectively induces axial movement of the ram removal bolt 14 relative to the base 12 in first (inward) and second (outward) axial directions D1,D2.

FIG. 5 is a view of a partially disassembly BOP with the bonnet removed to show the BOP body BD including a ram bore RB in which a ram RM is operatively positioned. An outer face OF of the ram includes the stud receiver notch RN as described above or another receiving notch or structure that is adapted to selectively receive and axially capture the stud 14d of the ram removal bolt 14 for ram removal operations.

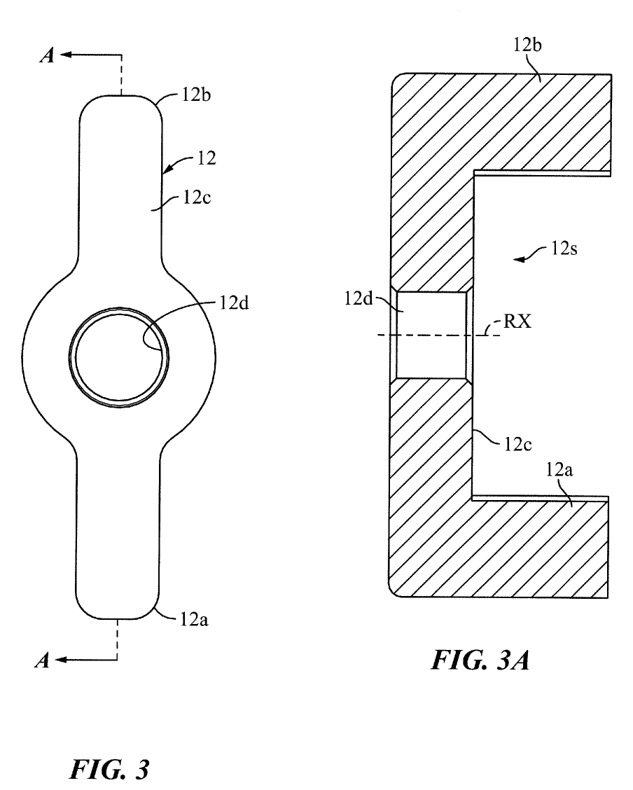

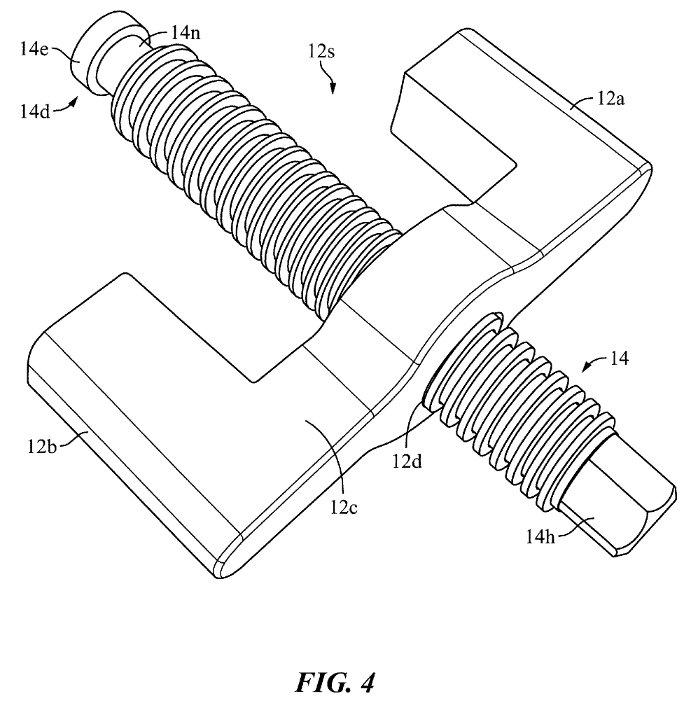

FIG. 6 is similar to FIG. 5, but also shows the BOP ram removal tool 10 of FIGS. 1-4 operatively engaged with the BOP body BD for removal of the ram RM from the ram bore RB, with the tool 10 shown in a first operative state in which the ram removal bolt 14 is advanced into the bore RB and advanced relative to the base 12 of the tool 10 and operatively engaged with (axially captured in) the stud receiver notch RN defined in ram outer face OF. When the base 12 of the tool 10 is operatively engaged with a BOP body BD as shown, the legs 12a,12b of the base are abutted with the BOP body BD on opposite sides of the ram bore RB and the crossbar 12c bridges or spans across the ram bore RB so that the ram removal bolt 14 is aligned with the stud receiver notch RN of the ram so that the stud 14d of the ram removal bolt 14 can be engaged with the stud receiver notch RN.

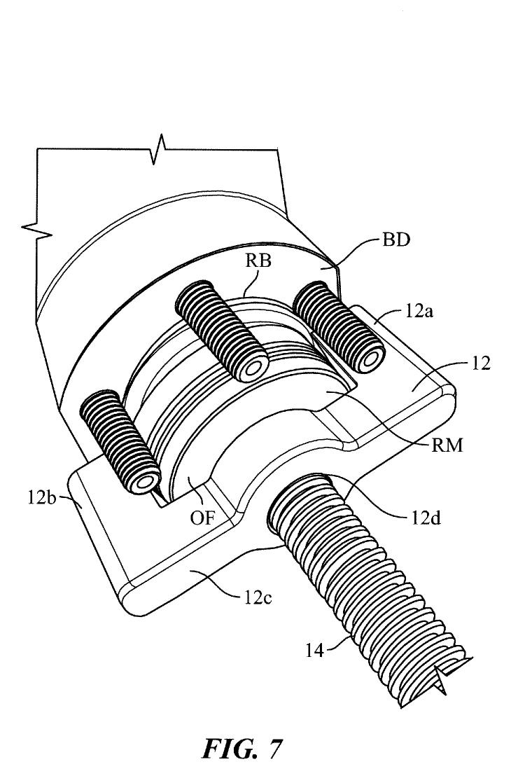

FIG. 7 is similar to FIG. 6, but shows the tool 10 in a second operative state in which the ram removal bolt 14 has been rotated sufficiently in the second direction relative to its position in FIG. 6 so that the ram removal bolt 14 and the ram RM axially captured thereto is retracted from the BOP ram bore RB and retracted relative to the tool base 12 so that the associated ram RM that is operatively engaged with the removal bolt is at least partially retracted from or withdrawn from the ram bore RB and into the ram receiving space 12s defined between the legs 12a,12b of the base 12 to facilitate removal of the ram RM from the ram bore RB.

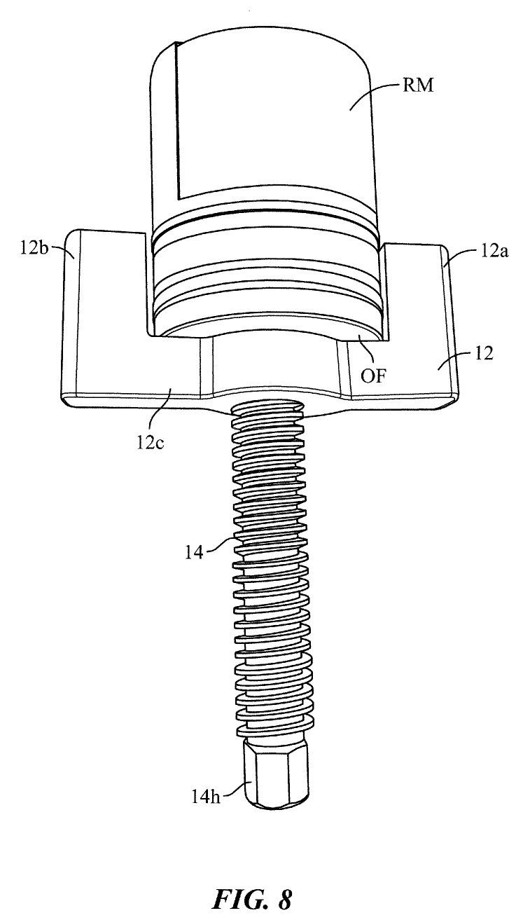

FIG. 8 shows the BOP ram removal tool 10 and associated ram RM operatively engaged therewith separated from the BOP body BD so that the ram RM can then be separated from the ram removal bolt 14 by advancing the bolt 14 from the position shown in FIG. 8 to a position where the ram engaging stud 14d of the ram removal bolt 14 can be disengaged from the stud receiver notch RN of the ram RM to allow repair and/or replacement of the ram RM.

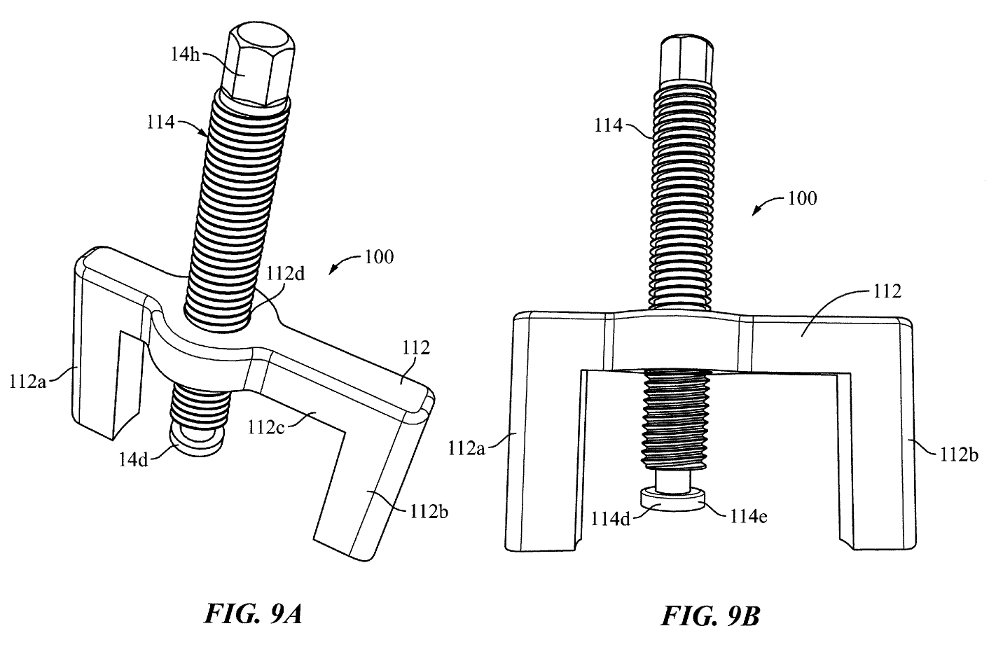

FIGS. 9A & 9B respectively provide an isometric view and a side view of a BOP ram removal tool 100 in accordance with an alternative embodiment of the present development. Except as otherwise shown and/or described, the ram removal tool 100 is identical to the ram removal tool 10, and like components are identified with like reference numbers that are 100 greater than those used in association with the ram removal tool 10. Unlike the ram removal tool 10, the ram removal tool 100 is structured such that the through-bore 112d of the crossbar 112c of the base 112 and the ram removal axis RX (not shown in FIGS. 9A & 9B) about which the through-bore 112d is coaxially defined and the ram removal bolt 14 are offset from the midpoint between the legs 112a,112b so that the through-bore 112d and ram removal bolt 14 are closer to or offset toward one of the legs 112a,112b than the other. In the illustrated example, the through-bore 112d and removal bolt 14 are offset toward and closer to the first leg 112a as compared to the second leg 112b which can be desirable depending upon the location of the stud receiver notch RN in the ram and/or depending upon the shape of the BOP body BD. For example, when the second portion RN2 of the receiver slot/notch RN is offset from a centerline of the ram RM, the through bore 112d and ram removal bolt 14 are correspondingly offset from a midpoint between the first and second legs 112a,112b so that the ram RM will be received between the first and second legs 112a,112b of the tool base 112 when the ram removal bolt 14 is retracted to extract the ram RM from the ram bore RB.

The terms "include" or "may include" used in the present disclosure indicate the presence of disclosed corresponding functions, operations, elements, and the like, and do not limit additional one or more functions, operations, elements, and the like. In addition, it should be understood that the terms "include", “including”, “have” or "having" used in the present disclosure are to indicate the presence of components, features, numbers, steps, operations, elements, parts, or a combination thereof described in the specification, and do not preclude the presence or addition of one or more other features, numbers, steps, operations, elements, parts, or a combination thereof.

The terms "or" or "at least one of A or/and B" used in the present disclosure include any and all combinations of words enumerated with them. For example, "A or B" or "at least one of A or/and B" mean including A, including B, or including both A and B.

Although the terms such as "first" and "second" used in the present disclosure may modify various elements of the different exemplary embodiments, these terms do not limit the corresponding elements. For example, these terms do not limit an order and/or importance of the corresponding elements, nor do these terms preclude additional elements (e.g., second, third, etc.) The terms may be used to distinguish one element from another element. For example, a first mechanical device and a second mechanical device all indicate mechanical devices and may indicate different types of mechanical devices or the same type of mechanical device. For example, a first element may be named a second element without departing from the scope of the various exemplary embodiments of the present disclosure, and similarly, a second element may be named a first element.

It will be understood that, when an element is mentioned as being "connected" or "coupled" to another element, the element may be directly connected or coupled to another element, and there may be an intervening element between the element and another element. On the contrary, it will be understood that, when an element is mentioned as being "directly connected" or "directly coupled" to another element, there is no intervening element between the element and another element.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise.

All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having inconsistent or exaggerated meanings unless they are clearly defined in the various exemplary embodiments.

This written description uses examples to describe the disclosure, including the best mode, and also to enable any person skilled in the art to make and use the disclosure. Other examples that occur to those skilled in the art are intended to be within the scope of the invention if they have structural elements that do not differ from the same concept or that do not differ from the literal language of the claims, or if they include equivalent structural elements with insubstantial differences from the same concept or from the literal language of the claims. Moreover, this disclosure is intended to seek protection for a combination of components and/or steps and a combination of claims as originally presented for examination, as well as seek potential protection for other combinations of components and/or steps and combinations of claims during prosecution.

Although specific advantages have been enumerated above, various embodiments may include some, none, or all of the enumerated advantages. Although exemplary embodiments are illustrated in the figures and description herein, the principles of the present disclosure may be implemented using any number of techniques, whether currently known or not. Moreover, the operations of the systems and apparatuses disclosed herein may be performed by more, fewer, or other components, and the methods described herein may include more, fewer, or other steps. Additionally, steps may be performed in any suitable order.

To aid the Patent Office and any readers of this application and any resulting patent in interpreting the claims appended hereto, applicants do not intend any of the appended claims or claim elements to invoke 35 USC 112 (f) unless the words “means for” or “step for” are explicitly used in the particular claim.

The disclosure has been described with reference to the preferred embodiments. Modifications and alterations will occur to others upon reading and understanding the preceding detailed description. It is intended that the claims be construed as including all such modifications and alterations while preserving the validity of the claims.

1. A blowout preventer ram removal tool comprising:
a base adapted to be engaged with an associated blowout preventer body such that said base spans an associated ram bore in which an associated ram is located;
a ram removal bolt engaged with the base and adapted to be selectively advanced and retracted relative to the base, wherein said ram removal bolt comprises a stud that is adapted to be mated with the associated ram;
wherein retraction of said ram removal bolt relative to said body when said stud of said ram removal bolt is mated with the associated ram retracts said the associated ram relative to the associated ram bore.

2. The blowout preventer ram removal tool as set forth in claim 1, wherein base comprises a threaded through bore and said ram removal bolt comprises helical threads that are threadably engaged with the threaded through bore such that rotation of said ram removal bolt in first and second opposite directions relative to the base respectively induces inward and outward axial movement of the ram removal bolt relative to said base.

3. The blowout preventer ram removal tool as set forth in claim 2, wherein said ram removal bolt comprises a bolt shaft including a first end including a driving head configured for being engaged by an associated driving tool used to rotate the ram removal bolt in said first and second opposite directions.

4. The blowout preventer ram removal tool as set forth in claim 3, wherein said bolt shaft comprises a second end located opposite said first end, said second end comprising a ram engagement stud adapted to be engaged with the associated ram.

5. The blowout preventer ram removal tool as set forth in claim 4, wherein said ram engagement stud comprises: (i) a reduced diameter neck that projects outward from the bolt shaft; and (ii) a flanged head located at an outer end of the reduced diameter neck and connected to the bolt shaft by the neck.

6. The blowout preventer ram removal tool as set forth in claim 5, wherein said ram engagement stud is formed as a one-piece construction with the ram removal bolt.

7. The blowout preventer ram removal tool as set forth in claim 4, wherein said base comprises a bridge structure comprising first and second legs connected by a crossbar, wherein said threaded through bore in which said ram removal bolt is threadably engaged is located in said crossbar.

8. The blowout preventer ram removal tool as set forth in claim 7, wherein said threaded through bore is located midway between the first and second legs of the base.

9. The blowout preventer ram removal tool as set forth in claim 7, wherein said threaded through bore is offset relative to a midpoint between the first and second legs of the base so as to be closer to one of the first and second legs as compared to the other of the first and second legs.

10. The blowout preventor ram removal tool as set forth in claim 7, wherein said first and second legs define a ram receiving space there between that is adapted to receive the associated ram retracted from the associated ram bore.

11. The blowout preventor ram removal tool as set forth in claim 10, wherein said first and second legs of the base are parallel and spaced-apart relative to each other and equal in length.

12. The blowout preventer ram removal tool as set forth in claim 10, wherein said base is a one-piece structure.

13. A blowout preventer ram removal process comprising:
engaging a base of a ram removal tool with a blowout preventer body such that said base spans a ram bore of said blowout preventer body in which a ram is located, wherein said ram removal tool includes a ram removal bolt threadably engaged with said base and adapted for being rotated in first and second directions relative to said base to respectively advance and retract said ram removal bolt relative to said base;
engaging the ram removal bolt with said ram in said ram bore;
rotating the ram removal bolt relative to the base in said second direction to retract the ram removal bolt relative to the base such that said ram removal bolt and said ram engaged with the ram removal bolt are moved outwardly relative to said ram bore.

14. The blowout preventer ram removal process as set forth in claim 13, wherein said step of engaging the ram removal bolt with said ram in said ram bore comprises inserting a stud of the ram removal bolt into a receiver notch of said ram.

15. The blowout preventer ram removal process as set forth in claim 14, wherein said receiver notch of said ram comprises a keyhole shape including a first portion and a second undercut portion connected to the first portion, and wherein the step of inserting the stud into the receiver notch comprises inserting a flanged head of the stud into the first portion of the receiver notch and then sliding the flanged head into the second undercut portion of the receiver notch so that the flanger head is axially captured in the second undercut portion of the receiver notch.

16. A blowout preventer comprising:
a body including a bore;
a ram movably located in the bore, wherein said ram comprising a receiver notch;
a ram removal tool including a base engaged with the body and a ram removal shaft rotatably engaged with the base, wherein rotation of the ram removal shaft in a first direction relative to the base advances the ram removal shaft toward the bore and rotation of the ram removal shaft in a second direction retracts the ram removal shaft away from the bore;
a first end of the ram removal shaft including a driving head;
a second end of the ram removal shaft including a stud that is captured in the receiver notch of the ram whereby rotation of said ram removal shaft in said second direction retracts said ram from said bore.
